(19) United States
(12) Patent Application Publication
(10) Pub. No.: US 2002/0143619 A1
(43) Pub. Date: Oct. 3, 2002

(54) System and method for winning discounts

(76) Inventor: Stephen P. Laurie, Shropshire (GB)

Correspondence Address: Robert H. Frantz, P.O. Box 23324, Oklahoma City, OK, 73123, US

(21) Appl. No.: 09/821,627

(22) Filed: Mar. 29, 2001

(51) Int. Cl. G06F 17/60

(52) U.S. Cl. 705/14; 705/26

(57) ABSTRACT

A system and method for interactively offering a product or service to a customer through play for incremental discounts. The customer will naturally play until he or she has achieved a level of discount from full price of the product or service, at which time the customer will purchase the item at a price which represents his or her “price point”. To elicit such a price point from each customer, each turn of play includes the possibility of loss of all accumulated discounts so that with each decision to continue play, the customer has a chance of losing all discounts and returning to a full-price offer. Play can be a random process, such as a randomly generated win/lose status, or play can be through participation in a game such as a quiz or question-and-answer session.

### BACKGROUND OF THE INVENTION

The Internet and World Wide Web have become ubiquitous to everyday life for individuals, companies, governments, and institutions around the world in the past few years. Besides enabling near-instant text communications in the form of e-mail, the Internet has also allowed companies to create web sites where “visitors” with web browser computers and devices may obtain information regarding the companies' products and services and even purchase those products and services directly from the web site.

This ability to find and purchase products over the Internet has been well-received by the buying public in recent years as security issues have been resolved. Many consumers now prefer to shop online over shopping in “bricks and mortar” stores because one can view more products in a shorter amount of time, make more price and feature comparison, and usually obtain a better value than traditional shopping methods yield.

In the “bricks and mortar” paradigm, before companies have set prices for their products, they conduct customer surveys and analyze sales data in order to derive a “demand curve” for the product in its respective market. When this is combined with the product's cost data, companies can effectively set a price which maximizes the company's profit from that product.

One problem with this method is that a company normally sets a single price for a product for all of its customers. Ideally, the company would prefer to differentiate the price according to what the customer is willing to pay, but this is difficult to do in the off-line, “bricks and mortar” or “real store” paradigm. For example, if the price is set too low, some customers may attach a higher value to the product and would still purchase the product at a higher price. In this case, the company is losing revenue by undercharging these customers. Other customers might not buy at the set price, but would be willing to buy if the price were slightly lower. These sales may still be profitable, but again, the company is losing them because of the single set price technique.

Making sales on-line offers possibilities of charging different customers different prices. There has recently been a lot of interest in techniques for doing this. One approach is to use sophisticated data mining techniques to profile customers. If a customer has a profile that suggests they might be less price sensitive for a particular product, then they may be quoted a higher on-line price for a product than a customer whose profile indicates that they are more price sensitive. This technique has a number of disadvantages. First, this method depends upon the on-line retailer knowing a great deal about the customer in order to generate the customer profile. Getting this level of information may be difficult, especially as customers are becoming increasingly sensitive about their on-line privacy and about the volume of information held about them. An even greater problem with this method is that sooner or later customers will realize that they are being charged different prices, which may generate a negative reaction by the company's client base. For example, someone who is charged a higher price for an identical good sold to others at a lower price is likely to become very angry about this. To further exacerbate this problem, these higher price customers are likely to be the retailer's most preferred customers. If a retailer indulges in this type of price differentiation, it will likely expose the company to considerable adverse publicity.

Online auctions are another well-known attempt to address the needs in the art. Online auctions available today provide real-time sales for certain items. Some online auctions provide pooled-bids and lot purchases instead of sales of single, one-of-a-kind items. The well-known arrangements for reverse auctions, normal auctions, and group purchase bidding typically require the bidder to accept a specific product and model in order to participate in the bidding process, and to participate in bidding during a specific time period of the auction. While this is a somewhat effective method for obtaining maximized sales prices during the auction period, it does not address the needs of the art during other time periods while the auction is closed.

Online auctions for pooled bids and lot purchases may still use the “one price fits all” technique, even though that one price is generated directly by customer demand. “Name your price” techniques, such as that used by Priceline.com, go further. Effectively, under “name your price” methods, each customer generates his or her own price which ideally should approximate to the price they each are willing to pay for a particular product. However, these techniques also have problems. First, with experience in the process, participating customers will be able to judge what price is likely to be accepted and will base their bids on this expected price, rather than what they are really willing to pay. “Name your price” auctions may also impose inconvenient conditions on the customer, such as not knowing in advance the precise product on which they are bidding.

Other online sales systems provide for various methods of issuing product discounts which may also gather sales data useful for analyzing consumer willingness to pay various prices for a product. Some systems require users or bidders to “register” in order to get a discount by giving personal information such as name, address, telephone and e-mail data. While some consumers are more than willing to divulge this personal information, many are not.

U.S. Pat. No. 5,620,182 issued to Rossides discloses a method for generating discounts by chance. Rossides identifies the potential of a random discount method to differentiate customers by price sensitivity, or by the “demand curve”. However, in the '182 patent, the inventor states that in relation to differentiating the price sensitivity of the customer, the presented method “does not purport to answer these questions well, only to a poor, partial solution.” The method in the Rossides '182 patent involves giving the customer the opportunity to “gamble” for a lower price rather than purchasing the good at full price. The patent recognizes that there is a problem in preventing would-be full price purchasers from trying for a discount, and it proposes two remedies for this.

The first remedy proposed by the '182 patent is to stop “losing” customers from purchasing the good, even at full price. This is not really a workable scheme in that the seller would lose not just potential full price sales buying at a discounted price, but also otherwise full price customers who try to win a discount and lose and are forbidden to make the purchase at all. There is also the difficulty of trying to prevent customers who “lose” from making full price purchases, a restriction which is both perverse and impractical. This disadvantage of the Rossides '182 method is unacceptable—a supplier will not support a sales system which results in the elimination of any potential buyers, o especially full-price buyers.

The second proposed remedy in the Rossides '182 patent is to put controls on the time at which the goods could be purchased. While this might work to a degree, it imposes considerable inconvenience on the purchaser. This may be perceived as “high pressure” sales, which may evoke certain undesirable consumer behavior, such as resistance to buy the product at all.

Therefor, there is a need in the art for an online sales method and system which provides for charging different customers different prices, which does not require large amounts of information about the customer, which is not seen by the customer as being unfair, and which does not rely upon time limits to create purchases at offered discounts prices.

### SUMMARY OF THE INVENTION

The present invention provides a method of selling goods and services which is also an entertainment for the customer. The method involves the customer selecting offers and winning varying levels of discounts. The method of winning discounts may be as simple as clicking a button to generate a random process which will decide whether the customer has “won” or “lost” additional discounts. Alternatively, it may involve answering quiz questions or undertaking some more complex game of skill or chance. The quiz questions may be designed to obtain other valuable marketing information, such as the customer's awareness of the seller's other products and competitive products. The customer does not have to pay to play and is no poorer if they lose, under the preferred embodiment. On the other hand, if they win, they gain the opportunity of purchasing goods at advantageous prices.

The method provides valuable information regarding consumer price differentiation according to price sensitivity, and especially addresses the well-known is difficulty of how to price an item for different groups of potential customers who attach different values to the product or services, and who exhibit different price sensitivity characteristics. One manifestation of this problem concerns travel companies such as airline or hotel groups. The marginal costs incurred in servicing an additional customer are often very low if the airline or hotel group has unused capacity. However, if they offer these unused seats or rooms at a sizable discount, this may have an unintended affect other full price sales. The invention provides a means of differentiating full price sales from discount sales and also of maximizing the income from these discount sales. The method reveals the customer's price sensitivity because a person who attaches a high value to a good will tend to stop the game at a lower level of discount than a customer who attaches a lower value to the good. In this way the method can achieve a higher average price than using flat discounts.

The method is especially well adapted to operate over an interactive electronic medium such as the Internet, a computer connected interactivity to one or more other computers, interactive television or a mobile telephone system. It can also be carried out via a terminal located in a retail establishment or other public place, or by means of a point of sale system.

The customer is presented by a selection of one or more offers. The selection is made by the offering system. An important feature is the selection varies each time the customer accesses the system. In the preferred embodiment the customer specifies their requirements in broad terms, such as “holidays in Europe in June”, and the system generates a selection of offers which meets these requirements.

Each offer has an initial price associated with it, which may or may not be the usual full price. However, an important feature of the system is that the customer may play to earn a higher rate of discount. If they lose then, in the preferred embodiment, the offer initial is withdrawn. The play may take the form of random process which decides whether the customer has won or lost according to preset probabilities. Alternatively, it may involve answering a quiz question within a short time frame or playing a game involving either chance or skill.

Another important feature of the preferred embodiment is that more than one level of discount is obtainable. The preferred way of accomplishing this is to allow the game to be played on the same offer repeatedly so that the discount is increased in increments.

If the customer loses an offer, then they can start the process on another offer. At any time the customer can opt to proceed with an offer. The sale is then concluded at the level of discount earned at that time.

The present invention effectively addresses the short comings of the available art, including the Rossides '182 patent. The key is not to offer the opportunity to win discounts on goods as an alternative to full price purchases. Instead the present invention involves a complete system by which special offers are selected and presented to the customer who can then win the right to a higher level of discount. In this way genuinely incremental sales are achieved. Should the customer lose the right to a discounted purchase of a particular good or service they can continue to try and win the right to purchase a similar good or service at a discount.

A further innovation involves offering discounts in increments. This has two important implications. First, it brings out more clearly the price sensitivity of the customer. Offering a single deep discount is a crude method of differentiating customers. In the incremental method the customer can see the discount they are earning mount up. They know what they stand to lose if they continue to try for higher discounts and will be tempted to stop early if they value the good. By contrast a potential purchaser who does not value the good very highly will press on to earn a sufficient discount for the offer to be attractive. Secondly, the incremental method means that it is not necessary to stop anyone making full price purchases of the good. Losing the levels of discount built up in the initial stages is a sufficient penalty for losing.

### BRIEF DESCRIPTION OF THE DRAWINGS

The figures presented herein when taken in conjunction with the disclosure form a complete description of the invention.

FIG. 1 shows a generalized arrangement of a bidding device, such as a web browser computer, and an offering system, such as an e-commerce web server.

FIG. 2 illustrates the logical flow of the method implemented by the offering system.

FIG. 3 sets forth the logical flow of an enhanced embodiment of the invention.

### DETAILED DESCRIPTION OF THE INVENTION

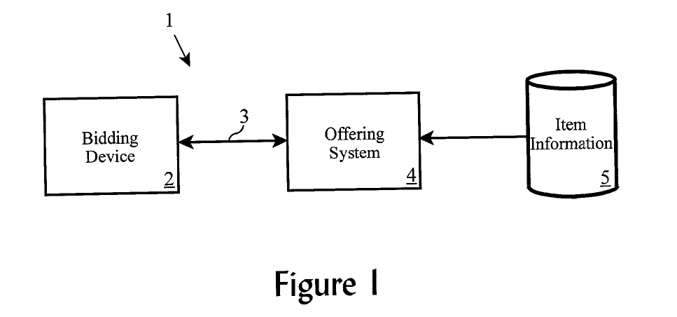

The method is intended to operate over an interactive electronic medium, such as the Internet, a computer connected interactively to one or more other computers, interactive television or a mobile phone system. It can also be carried out via a terminal located in a retail or other public place or by means of a point of sale system. As such, the generalized arrangement (1) shown in FIG. 1 is adopted. In the preferred embodiment, the bidding device (2) is a well-known Internet browser computer, the offering system (4) is an e-commerce web server equipped with a product and sales database (5), and the two are communicatively interconnected by the Internet (3) using a protocol such as Hyper Text Transfer Protocol (“HTTP”) over Transmission Control Protocol/Internet Protocol (“TCP/IP”). Alternatively, the bidding device (2) may be a common telephone, the communication media (3) may be a telephone network, and the offering system (4) may be a voice response unit adapted to provide audible messages and to receive voice or multi-frequency key input as selections. In still another configuration, the bidding device (2) may be a point-of-sale terminal, such as a cash register or automatic teller machine (“ATM”), the offering system (4) may be a ATM server or cash register server, and the communications medium (3) may be a computer network or the telephone network. Still another exemplary configuration includes a web-enabled wireless telephone, such as a cellular, GSM or PCS telephone, a wireless telephone network and a wireless web server. As demonstrated here, FIG. 1 represents many possible alternative configurations for implementing the invention.

Therefore, the remainder of the disclosure provides details of the implementation of the method as process executed by the offering system in the preferred embodiment. However, an alternative embodiment may be to realize the method fully in the bidding device, such as by Java scripts or a special application program in a web browser computer. Or, the functionality and logic of the method may be realized in a divided fashion between the offering system and the bidding device, such as coordinating and cooperating Java scripts on the bidding system and Java servlets on the offering system. It is also possible to realize the entire invention within a single device, such as a vending machine, wherein the bidding device and the offering system are physically integrated with each other.

Registration

The method can work with or without prior registration of the customer. In many cases, registration is convenient and is a useful mechanism for not presenting the same offers to the customer more than once. However, in other situations registration may discourage the customer from playing for a discount.

In the preferred embodiment registration is not required. If the customer is required to register, then they could be required to enter credit card details for any purchases made. These credit card details could be used as a mechanism for confirming that the customer is who they say they are and for stopping the customer registering more than once.

Keeping Track of the Session

Records of each session will be kept on the computer system running the game/shopping sessions. The customer will need some way of enabling them to keep track of each session. For example, they may want to pause a session and come back to it later-perhaps after they have researched the goods or services being offered. They will also need some mechanism of being able to make purchases at the discount they have earned. There are various ways of doing this. In some methods the customer is given a “handle” or code which enables them to select the session. In other methods the system can directly or indirectly identify the customer.

Well-known methods for tracking the progress of the game can be used, both with registered playing and anonymous playing, such as depositing “cookies” on the customer's bidding device or establishing a game session for the customer.

An example of the handle method is where the session takes place over the Internet. One or more unique web pages can be generated for each session. The customer's browser would be given the address of this web page so that only they could access the session. By saving the address of the page they could return some time later to the session if they needed to.

An example of where the system can identify the customer is where registration is required. In this case the customer would log on by supplying a user name and password. Another example is where the system can identify the apparatus being used by the customer. For example, a mobile phone or Interactive television might be capable of identification by the system. On the Internet it is possible to set cookies so that the system can recognize a particular computer.

In the case of an interactive terminal in a public place the terminal would be uniquely identified and the session would take place while the customer was physically using the terminal. At the end of the session a purchase could be made by inputting credit card details or the terminal could give the customer a unique code to claim the offer some other way.

It is within the skill of the art for selection of these implementation options, and realization in any suitable programming or hardware logic, such as “C” programming or Java.

Offer Selection

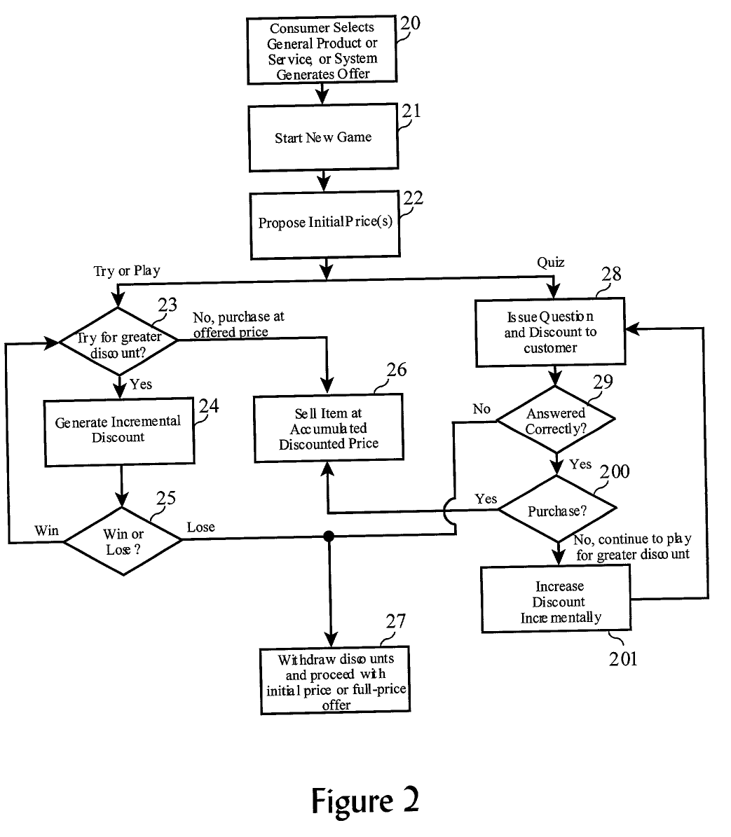

Turning the FIG. 2, the method of the invention is disclosed. The customer may have already registered, if that is optionally included in the implementation, prior to beginning the process of FIG. 2.

First, the user is prompted to select (20) a general product or service, such as “Holidays in Europe” or “digital cameras”. There are various ways in which this selection can be made. In the preferred embodiment the customer provides some information on the range of offers which they are interested in. This could be very wide (e.g. “give me a deal”) or more specific (e.g. “I am interested in a holiday in Europe for the second week in June”). If it is too specific (e.g. “I am interested in a flight from Dallas to New York for the evening of the 20^{th of} November”), the request may be rejected and the customer will be asked to widen the range.

An alternative mechanism for accomplishing the same result is for the customer to click on menu items to be presented with a selection of all offers which are valid at that time. In this case the offers are not customized to the particular individual session. However, the offers are changed very frequently (for example every few minutes) to make it hard for a customer to play the game on the same offer too many times.

In another alternate embodiment, the customer may be presented automatically with a selection of one or more offers. These offers might be generated randomly, or might be based upon characteristics of the customer or upon the customers interaction with the system. For example, a customer visiting a web site offering comupters who clicks for information on printers might be presented with the opportunity of winning a discount on a particular model or models of printer.

Once a selection of offers has been made, a new game session is established (21).

Next, the customer is presented with a one or more offers (22). Given the request the system will generate a number of special offers which will be customized to the particular customer request. The selection of offers may include a random element. The random element is particularly important where there is no registration as it is one way of presenting a different selection of offers for each session. The initial offer or offers may be already discounted from list price or full price, and this initial discount is preferably not specifically disclosed to the customer.

In addition to offers which meet the criteria the system may also present additional special offers or offers which may be attractive to the profile of the customer. 10

Winning a Higher Discount

The customer can choose one or more offers from the selection and try to win a higher discount: (a) play or try for a better discount, or (b) play a game or quiz for additional discounts. Both formats may be implemented in the same system, or a system may only offer one of the formats.

In the preferred embodiment in the random play or try format, the customer would select an offer and be given the option (23) of either making the purchase or pressing a “go for a discount” button. If they win (25) then they would achieve a specified incremental discount (24). If they lose, then the offer is deleted from the selection, and full price purchasing is offered (27).

Assuming they win, then the price would be updated to reflect the increased discount. They would then be presented with the option of buying the good at that price or trying again for a higher level of discount (23). The process could be repeated a number of times until either the customer had purchased the good at a price he or she preferred (e.g. their “price point”), had lost the offer, or until the price had reached an optional minimum level (e.g. which could be zero so that the customer had won the good for free). If the customer lost an offer then they could select another offer and repeat the process.

In this embodiment, the consumer is faced with the possibility of losing the accrued discount each time the play or try option is chosen. This possibility evokes the consumer behavior to purchase the item at the maximum price he or she is willing to pay.

A variation is for the customer to have the ability to set the offer aside and select another offer. For example, if the customer was interested in two holidays A and B and had received a discount of 30% on A they might then put A aside and try for a discount on B. If they lose, then they could go back to A and either purchase it or try for a higher discount.

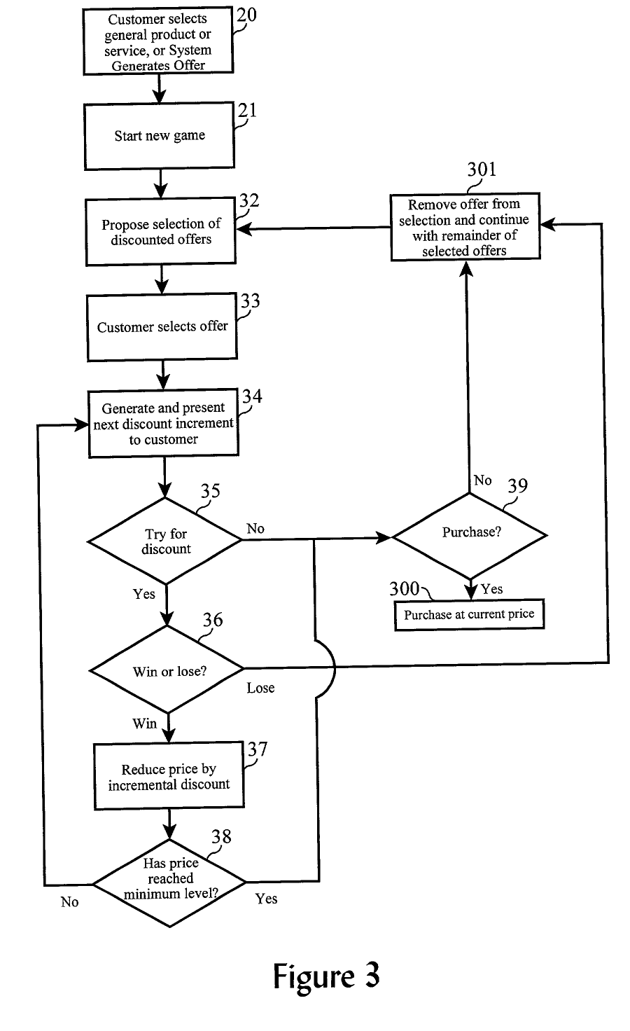

Turning to FIG. 3, a more detailed representation of the preferred embodiment of the random game format is given. The customer would choose a level of discount and try to win that level of discount, according to this embodiment. The higher the level of discount selected, the lower the chances of winning. Optionally, multiple offers for products may be given, each with different prices and levels of discount. For example, three printers, a basic unit, and middle-range unit, and a top-of-the-line unit could all three be offered (32), the customer could select one to play for (33), and then play would continue for incremental and accumulating discounts (34, 35, 36, and 37) until a minimum price is reached (38), the game is lost and the offer withdrawn (301), or the customer decides to purchase the item (300). Then, play for another one of the offered items could be made by selecting another offer (32), especially if the previous offer had resulted in a loss of the accumulated discounts.

A further variation is for the offer not to be withdrawn but for the earned level of discount to be wholly or partially removed. Another possible variation is for the customer to have one or more “lives” before the offer is withdrawn.

In the preferred embodiment, the play or try would be in the form of the generation of a random number and comparison against a specified probability. This probability might or might not be revealed to the customer. The method could involve various presentations to the customer of this random generation-for example a spinning roulette wheel, throwing the dice, drawing cards or any other similar presentation.

Other embodiments may involve conducting various games of chance or skill to earn a discount. Such games could include, for example, answering quiz questions, as shown in FIG. 2. As the discount increases the level of difficulty of the question may increase. There are many other games that could be played to earn the discount.

In this embodiment, the customer would be given a discount which he or she is playing to win, and a corresponding question (28). If the customer answers the question correctly (29), he or she is given the option to purchase (200) the item at the discounted price, or to continue playing for higher discounts. If the customer chooses to continue to play (201), the discount may be increased by a set amount or a random amount, and a new question is proposed (28). As in the random try format, this process may continue until the customer loses and the offer is fully or partially withdrawn (27), or the customer achieves a price he or she is willing to pay and the purchase is made (26) at the discounted price. Other variations as described for the random game format may also be taken to this basic scheme of playing a game to earn or win discounts.

Purchasing

The customer has the option at any time to purchase any of the outstanding offers at the prevailing price. Clearly the seller will need to know what level of discount the buyer qualifies for. This is achieved through one of the methods for keeping track of the session. Otherwise, the purchase is straight forward. If they have previously registered then the purchaser's details will already be stored on the seller's computer. Otherwise, the purchaser will enter their details including credit card details or other method of payment to complete the purchase.

Variations

In the preferred embodiment any offer generated is non-binding on the customer. They are free to “walk away” at any time until they commit. However, a variation is for the offer to be binding on the customer at the time of the executing the play or try. If they win, then they must take out the offer at the lower price. If they lose then the offer is withdrawn. This option may be governed by regulatory laws in certain jurisdictions, and as such, certain probabilistic features would be implemented to meet such regulations.

One risk that needs to be guarded against is that some customers will try and win deep discounts by making successive tries at the same offer. In the preferred embodiment the barrier to this is that each selection is unique and the customer is not guaranteed to get the same offer again. An alternative is for the software to detect circumstances where an individual is making successive similar requests and adjust deals offered and probabilities accordingly. It could do this on the Internet through setting cookies. Alternatively, it could identify repeated offer range requests and attempts at the same offers and alter the probabilities for such attempts.

A further variation is for the offers to be in the form of bundles of goods. For example, the system could select two lists of goods and the customer can choose any combination of two goods one from each list. The customer could try for greater discounts in the same way as above. If they lose then both the goods could be eliminated from the lists. Each time the customer played the bundles presented could be different.

Principles Achieved by the Method

The purpose of the method from the perspective of the seller is:

(1) to achieve incremental sales which would not otherwise be made;

(2) to minimize the level of discount required to achieve such sales.

The first step in achieving incremental sales is to attract potential customers in volume and then to get them to consider offers which they might not otherwise see. Both objectives are fulfilled by the game format. Because of the fun format the method should attract potential purchasers who will play out of curiosity and because they have nothing to lose. These potential purchasers will then be presented by offers and given the chance to win a discount. Once they have won a discount they will be tempted to actually purchase the good.

The second step in achieving genuinely incremental sales is to make it difficult for full price customers from purchasing the offer at a discounted price. To do this the method constructs two barriers between full purchases of the good and the ability to make discounted purchases. First, a selection of goods is presented and this selection is continually changing. If an individual has a specific good which they are interested in then they are unlikely to find that good in any selection which they are presented with. The second barrier is that the customer has to win a discount. There is a reasonable probability that the customer cannot win a large discount on any particular good and a customer valuing the good sufficiently to make a full price purchase is likely to stop at a moderate discount.

The method has the further advantage over straight-forward discounts of generating a higher average price provided a sale is made. The system will result in prices which vary according to the price sensitivity of the buyer. For example, a buyer may be less price sensitive because they attach a high value to the particular good or service being offered. Such a buyer is more likely to go for an option with a high probability of winning because they will fear losing the offer. On the other hand a buyer may be more price sensitive because they have limited resources or because they are relatively indifferent to the particular good or service being offered. Such a buyer is likely to try for a bargain price with a lower probability of winning. In this way the system automatically generates higher prices from less price sensitive customers and lower prices from customers who would not purchase the good or service at full price.

One potential disadvantage is that sales might be lost because the method involves refusing to make sales to losing customers. A customer might have been willing to purchase a good at a prevailing rate of discount but might lose the right to purchase the good by trying to gain a higher rate of discount. The method solves this potential disadvantage by making it easy for the customer to win at least one offer. A series of offers is presented to the customer and there are low barriers to replaying the game if they lose.

What is claimed is:

1. A method for selling a good or service to a customer while providing entertainment to that customer, said method comprising the steps of:
issuing to said customer at least one initial offer price having an initial price for a product or service;
receiving a choice input from said customer to either accept the offer and make a purchase of the product or service at the offered price, or to play for a lower price and greater discount;
responsive to receiving a choice to play for a lower price, issuing an incrementally discounted price until the customer chooses to purchase the product or until play is terminated, which ever occurs first.

2. The method as set forth in claim 1 further comprising the step of allowing the customer to purchase the product at a full price upon termination of play.

3. The method as set forth in claim 1 wherein said play is randomly terminated by use of a random chance device.

4. The method as set forth in claim 1 wherein said incremental discount is set randomly within predetermined bounds.

5. The method as set forth in claim 1 wherein said step of issuing an incrementally discounted price comprises the steps of:
issuing a question to said customer;
receiving an answer from said customer in response to said question;
responsive to receipt of a correct answer, offering said customer a choice to continue to play for further discounts, or otherwise, terminating play in response to an incorrect answer.

6. A computer readable medium containing program code for selling a good or service to a customer while providing entertainment to that customer, said program code when executed by a computer causing the computer to perform the steps of:
issuing to said customer at least one initial offer price having an initial discount price;
receiving a choice input from said customer to either purchase the product at the offered price or to play for a lower price and greater discount;
responsive to receiving a choice to play for a lower price, issuing an incrementally discounted price until the customer chooses to purchase the product or until play is terminated, which ever occurs first.

7. The computer readable medium as set forth in claim 6 further comprising program code for allowing the customer to purchase the product at a full price upon termination of play.

8. The computer readable medium as set forth in claim 6 further comprising program code for randomly terminating play by use of a random number generator

9. The computer readable medium as set forth in claim 6 wherein said program code for issuing incrementally discounted offer prices is adapted to randomly set each incremental discount within predetermined bounds.

10. The computer readable medium as set forth in claim 6 wherein said program code for issuing an incrementally discounted price further comprises program code for performing the steps of:
issuing a question to said customer;
receiving an answer from said customer in response to said question;
responsive to receipt of a correct answer, offering said customer a choice to continue to play for further discounts, or otherwise, terminating play in response to an incorrect answer.

11. The computer readable medium as set forth in claim 6 wherein said program code comprises point-of-sale terminal program code.

12. The computer readable medium as set forth in claim 6 wherein said program code comprises Internet web server program code.

13 The computer readable medium as set forth in claim 6 wherein said program code comprises telephone automated attendant program code.

14. A system for selling a good or service to a customer while providing entertainment to that customer, said system comprising:
a bidding terminal for displaying information from the computer and receiving user input by the computer;
an offering system having a processor capable of executing program code; and
program code disposed in said offering system, said program code when executed by said offering system processor causing the offering system to perform the steps of:
issuing to said customer at least one initial offer price having an initial price;
receiving a choice input from said customer to either purchase the product at the offered price or to play for a lower price and greater discount;
responsive to receiving a choice to play for a lower price, issuing an incrementally discounted price until the customer chooses to purchase the product or until play is terminated, whichever occurs first.

15. The system as set forth in claim 14 wherein said offering system program code further comprises program code for allowing the customer to purchase the product at a full price upon termination of play.

16. The system as set forth in claim 14 wherein said offering system program code further comprises program code for randomly terminating play by use of a random number generator.

17. The system as set forth in claim 14 wherein said offering system program code further comprises program code for issuing incrementally discounted offer prices is adapted to randomly set each incremental discount within predetermined bounds.

18. The system set forth in claim 14 wherein said offering system program code further comprises program code for issuing an incrementally discounted by:
issuing a question to said customer;
receiving an answer from said customer in response to said question;
responsive to receipt of a correct answer, offering said customer a choice to continue to play for further discounts, or otherwise, terminating play in response to an incorrect answer.

20. The system as set forth in claim 14 wherein said bidding device comprises a point-of-sale terminal.

21. The system as set forth in claim 14 wherein said bidding device comprises a web browser computer.

22. The system as set forth in claim 14 wherein said offering system comprises a web server computer.

23. The system as set forth in claim 14 wherein said bidding device comprises a telephone.

24. The system as set forth in claim 14 wherein said offering system comprises an automated attendant program code.

25. The system as set forth in claim 14 wherein said offering system comprises a vending machine.
